(19) United States
(12) Patent Application Publication
(10) Pub. No.: US 2004/0208493 A1
(43) Pub. Date: Oct. 21, 2004

(54) Video signal processing apparatus, video signal processing method, imaging apparatus, reproduction apparatus, and reception apparatus

(76) Inventors: Kotaro Kashiwa, Kanagawa (JP); Shigeru Akahane, Kanagawa (JP)

Correspondence Address: FROMMER LAWRENCE & HAUG LLP, 745 FIFTH AVENUE, NEW YORK, NY, 10151, US

(21) Appl. No.: 10/824,912

(22) Filed: Apr. 15, 2004

(30) Foreign Application Priority Data
Apr. 17, 2003 (JP) P2003-112377

(51) Int. Cl. H04N 5/76; H04N 5/225

(52) U.S. Cl. 386/117; 348/207.99

(57) ABSTRACT

The present invention aims at simplifying configurations of devices compliant to a plurality of simultaneously imaged video signals. A plurality of imaging means 101 and 102 obtains a plurality of imaged video signals P1 and P2. These signals are selected at a vertical synchronization timing (104) to generate one system of composed video signal Pmix0. Compression means 105 compresses the composed video signal Pmix0 to record or transmit it. Decompression means 107 decompresses a compressed and composed video signal Pmix2 which is reproduced from a recording medium or is received. A video decomposition process can recover an original plurality of systems of video signals simply by selecting the signals at the vertical synchronization timing (109). An interpolation process is performed for a field that is lost due to the field-based selection during composition.

### BACKGROUND OF THE INVENTION

1. Field of the Invention

The present invention relates to a video signal processing apparatus, a video signal processing method, an imaging apparatus, a reproduction apparatus, and a reception apparatus. More specifically, the present invention relates to processing of a plurality of synchronized video signals.

2. Description of Related Art

Imaging apparatuses are widely spread for business and home uses in the form of portable video cameras, for example.

As described in JP-A No. 212748/1995, various technologies are proposed to use the imaging apparatus as a monitoring camera.

In recent years, for example, it is proposed to provide a single imaging apparatus (video camera) with two camera sections so as to be able to simultaneously capture two systems of imaged video signals. For example, such imaging apparatus is mounted with a main camera and a sub-camera to be able to image objects from different directions and zoom states or to simultaneously image forward and backward scenes.

Obviously, such imaging apparatus capable of capturing a plurality of systems of imaged video signals has a plurality of circuit systems for processing imaging signals.

For example, FIG. 9 shows a configuration example of an imaging apparatus that compresses an imaged video signal to record it on a disk or other recording media.

The imaging apparatus in FIG. 9 comprises a first camera section 201 and a second camera section 202.

Each of the first and second camera sections 201 and 202 has a lens system, a CCD imaging element, a video signal process circuit, and the like. In response to imaging, the first and second camera sections 201 and 202 output imaged video signals P1 and P2, respectively.

A synchronization signal generation section 203 generates a common synchronization signal SY. Based on the synchronization signal SY, the first and second camera sections 201 and 202 process imaged video signals. That is to say, the camera sections 201 and 202 synchronously perform imaging.

A circuit section as a first compression system 204 compresses the imaged video signal P1 from the first camera section 201 according to the MPEG, for example.

Likewise, a circuit section as a second compression system 205 compresses the imaged video signal P2 from the second camera section 202.

A recording circuit is supplied with the imaged video signal compressed in the first compressing system 204 and the imaged video signal compressed in the second compressing system 205. These signals are recorded as independent video data on a recording medium 90.

The two simultaneously obtained video signals are recorded alternately in a time sharing manner. When there is provided a recording mechanism having a plurality of recording heads, the video signals are recorded concurrently.

During reproduction of recorded video signals, the video signal captured by the first camera section 201 is reproduced from the recording medium 90, and then is supplied to a circuit as a first decompression system 207. The first decompression system 207 performs a decompression process corresponding to the above-mentioned compression process.

The video signal captured by the second camera section 202 is reproduced from the recording medium 90, and then is supplied to a circuit as a second decompression system 208. The second decompression system 208 performs a decompression process corresponding to the above-mentioned compression process.

The video signals are decompressed in the first and second decompression systems 207 and 208, and then are supplied to display sections 209 and 210 for display.

As mentioned above, the imaging apparatus comprising a plurality of camera sections requires two similar signal processing circuits for two systems of imaged video signals. For example, there are needed the first and second compression systems 204 and 205 and the first and second decompression systems 207 and 208 as shown in FIG. 9. The recording system must support sophisticated features such as high-speed recording and time sharing recording in order to record two systems of simultaneously supplied video signals on the recording medium 90. Alternatively, the recording system is inevitably subject to a complicated configuration such as the multi-head mechanism.

Consequently, there are problems of complicating the configuration, greatly increasing costs, and enlarging the circuit scale.

### SUMMARY OF THE INVENTION

It is therefore an object of the present invention to aim at miniaturizing and simplifying a circuit scale, reducing costs, and the like in terms of an apparatus that simultaneously processes a plurality of systems of synchronized video signals.

For this purpose, a video signal processing apparatus according to the present invention comprises composition means for sequentially selecting a plurality of video signals supplied synchronously with the same synchronization signal at a vertical synchronization timing of the synchronization signal to obtain a composed video signal comprising a composition of the video signals; and compression means for compressing a composed video signal obtained by the composition means.

Recording means records on a recording medium a compressed and composed video signal compressed by the compression means. Alternatively, transmission means transmits that signal.

The video signal processing apparatus according to the present invention also comprises decompression means for applying a decompression process to the compressed and composed video signal in correspondence with the compression process to obtain a decompressed composed video signal; and video decomposition means for sequentially selecting a composed video signal output from the decompression means at a vertical synchronization timing to obtain a plurality of video signals.

The video signal processing apparatus according to the present invention further comprises interpolation means for interpolating a video signal output from the video decomposition means.

In these cases, the compressed and composed video signal is reproduced by reproduction means or is received by reception means.

A video signal processing method according to the present invention sequentially selects a plurality of video signals supplied synchronously with the same synchronization signal at a vertical synchronization timing of the synchronization signal to obtain a composed video signal comprising a composition of the plurality of video signals; compresses the composed video signal; and records on a recording medium or transmitting the compressed and composed video signal.

The video signal processing method according to the present invention applies a decompression process to the compressed and composed video signal in correspondence with the compression process to obtain a decompressed composed video signal; and sequentially selects the composed video signal at a vertical synchronization timing to output a plurality of video signals. The method also interpolates the output video signal.

An imaging apparatus according to the present invention comprises synchronization signal generation means; a plurality of imaging means for performing imaging based on a synchronization signal from the synchronization signal generation means to output an imaged video signal; composition means for sequentially selecting a plurality of imaged video signals obtained by the plurality of imaging means at a vertical synchronization timing of the synchronization signal to obtain a composed video signal comprising a composition of the plurality of imaged video signals; and compression means for compressing a composed video signal obtained by the composition means.

Recording means records on a recording medium a compressed and composed video signal compressed by the compression means. Alternatively, transmission means transmits that signal.

A reproduction apparatus according to the present invention comprises reproduction means for reproducing the compressed and composed video signal from a recording medium; decompression means for decompressing a compressed and composed video signal reproduced by the reproduction means from a recording medium in correspondence with the compression process to obtain a decompressed composed video signal; and video decomposition means for sequentially selecting a composed video signal from the decompression means at a vertical synchronization timing to obtain a plurality of video signals. The reproduction apparatus further comprises interpolation means for interpolating a video signal output from the video decomposition means.

A reception apparatus according to the present invention comprises reception means for receiving the compressed and composed video signal; decompression means for decompressing a compressed and composed video signal received by the reception means in correspondence with the compression process to obtain a decompressed composed video signal; and video decomposition means for sequentially selecting a composed video signal from the decompression means at a vertical synchronization timing to obtain a plurality of video signals. The reception apparatus further comprises interpolation means for interpolating a video signal output from the video decomposition means.

As mentioned above, the present invention sequentially selects and composes a plurality of systems of synchronized video signals (e.g., imaged video signals) at a vertical synchronization timing. Specifically, each system of imaged video signals is selected in units of fields of the video signal to generate one system of composed video signal. Accordingly, compression means just needs to comply with one system of composed video signals.

The video signal composed and compressed in this manner can be decompressed, and then sequentially selected in units of fields, for example, to recover the original plurality of systems of video signals. Further, it is a good practice to interpolate a field that is lost due to the field-based selection during the composition.

### BRIEF DESCRIPTION OF THE DRAWINGS

FIG. 1 is an explanatory diagram of basic configuration concept for the present invention;

FIG. 2 is an explanatory diagram of a composition process according to the present invention;

FIG. 3 is an explanatory diagram of a video decomposition process according to the present invention;

FIG. 4 is an explanatory diagram showing an external view of a video camera according to an embodiment of the present invention;

FIG. 5 is an explanatory diagram illustrating a form of using the video camera according to the embodiment;

FIG. 6 is an explanatory diagram showing imaging angles of field of the video camera according to the embodiment;

FIG. 7 is an explanatory diagram showing a system configuration using the video camera according to the embodiment;

FIG. 8 is a block diagram showing a configuration of the video camera according to the embodiment; and

FIG. 9 is an explanatory diagram showing an imaging apparatus to obtain a plurality of systems of imaged video signals.

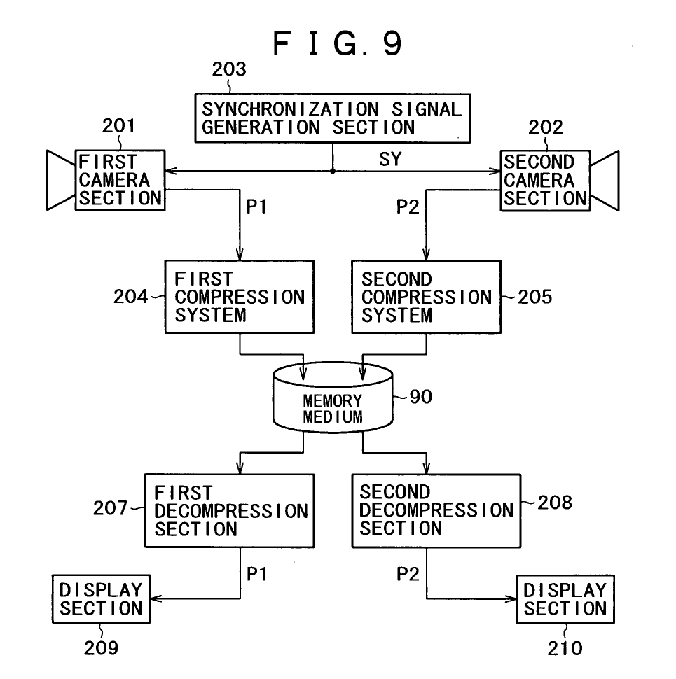

### DETAILED DESCRIPTION OF THE PREFERRED EMBODIMENTS

Embodiments of the present invention will be described in further detail.

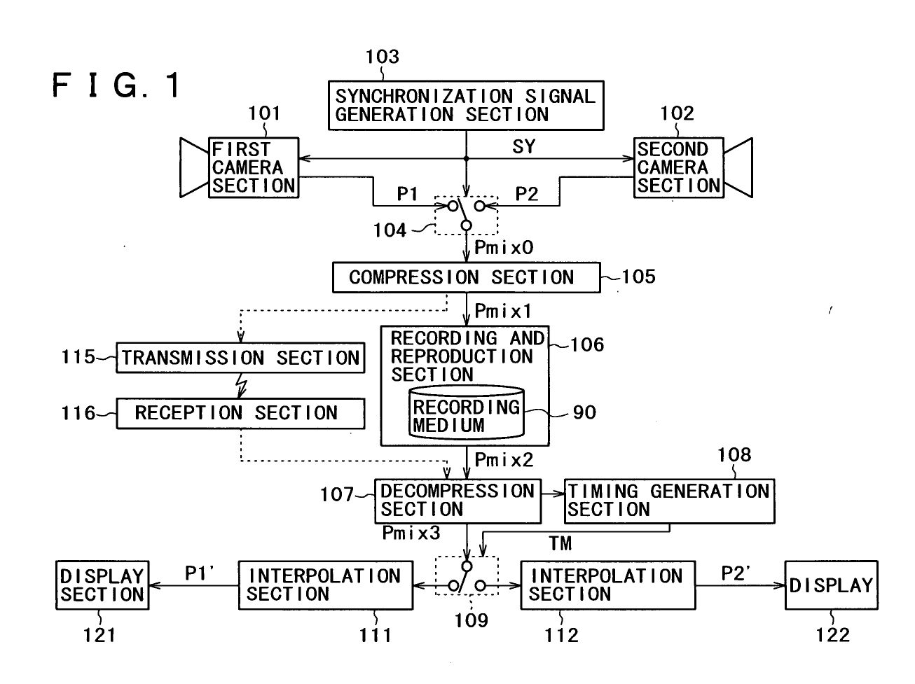

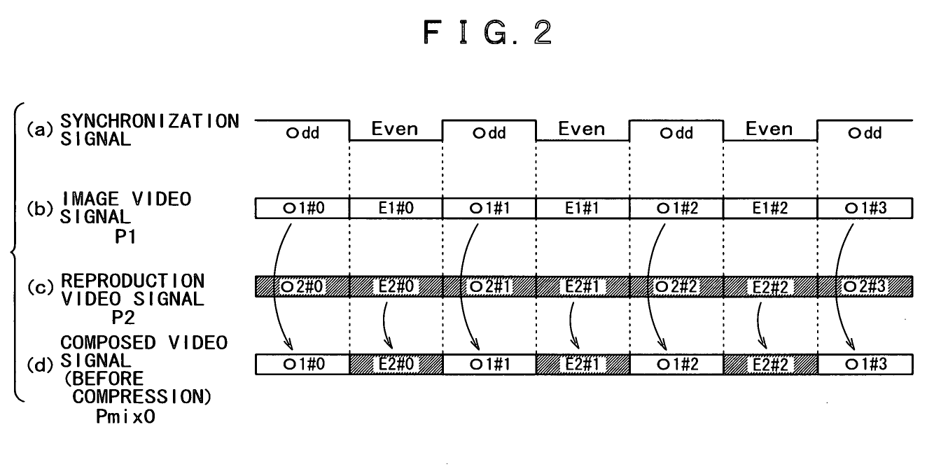

With reference to FIGS. 1 and 2, the following describes the basic configuration applied to the embodiment.

According to this example, a single imaging apparatus (video camera) comprises two camera sections, i.e., a first camera section 101 and a second camera section 102 as shown in FIG. 1. For example, the first camera section 101 works as a main camera, and the second camera section 102 as a sub-camera. Alternatively, the one is configured to image forward and the other backward. An actual device is provided with any configuration of image directions, imaging ranges (angles of field), functions such as zooming, pan, and the like of the two camera sections 101 and 102.

Each of the first and second camera sections 101 and 102 has a lens system, a CCD imaging element, a video signal process circuit, and the like. In response to imaging, the first and second camera sections 201 and 202 output imaged video signals P1 and P2, respectively.

A synchronization signal generation section 103 generates a common synchronization signal SY. Based on the synchronization signal SY, the first and second camera sections 101 and 102 process imaged video signals. That is to say, the camera sections 101 and 102 synchronously perform imaging.

The first and second camera sections 101 and 102 output imaged video signals P1 and P2 which are then supplied to a video composition section 104.

The video composition section 104 is supplied with a synchronization signal SY from the synchronization signal generation section 103. The video composition section 104 is configured to select signals based on the synchronization signal SY. Specifically, the video composition section 104 selects video signals by changing connection terminals based on each vertical synchronization timing.

When interlaced video signals are used for the imaged video signals Plan P2, the video composition section 104 selects and outputs the imaged video signals P1 and P2 in units of fields.

FIG. 2 schematically shows this process.

FIG. 2(a) represents the vertical synchronization timing of the synchronization signal SY in the form of Odd/Even for each vertical period. That is to say, the timing is equivalent to odd-numbered and even-numbered fields of an video signal.

As shown in FIG. 2(b), the first camera section 101b outputs the imaged video signal P1. In this signal, odd-numbered fields are represented as O1#0, O1#1, and soon, and even-numbered fields are represented as E1#0, E1#1, and so on.

As shown in FIG. 2(c), the second camera section 102b outputs the imaged video signal P2. In this signal, odd-numbered fields are represented as O2#0, O2#1, and soon, and even-numbered fields are represented as E2#0, E2#1, and so on.

To perform a changeover operation, for example, the video composition section 104 selects the imaged video signal P1 at the timings of odd-numbered fields. The video composition section 104 selects the imaged video signal P2 at the timings of even-numbered fields.

Consequently, the video composition section 104 outputs a video signal comprising concatenated fields such as O1#0, E2#0, O1#1, E2#1, O1#2, E2#2, and so on as shown in FIG. 2(d). That is to say, there is generated a composed video signal Pmix0 comprising an alternate sequence of odd-numbered fields of the imaged video signal P1 and even-numbered fields of the imaged video signal P2.

The composed video signal Pmix0 is supplied to a compression section 105. The composed video signal Pmix0 is then subject to a compression process according to the MPEG or JPEG system, for example, and is transformed into a compressed and composed video signal Pmix1.

The compressed and composed video signal Pmix1 is supplied to a recording and reproduction section 106 and is recorded on a specified recording medium 90. That is to say, the imaged video signals P1 and P2 are composed and compressed into the compressed and composed video signal Pmix1 that is recorded as one video content.

For example, the recording medium 90 may be available in various forms such as a disk, a memory card, and magnetic tape attached to the video camera, or an HDD (hard disk drive) and semiconductor memory installed in the video camera.

When the recording and reproduction section 106 reproduces a video signal from the recording medium 90, the reproduced video signal Pmix2 indicates the state of the above-mentioned video signal Pmix1, i.e., the compressed and composed video signal.

This reproduced compressed and composed video signal Pmix2 is supplied to a decompression section 107. The decompression section 107 performs a decompression process in correspondence with the compression process in the above-mentioned compression section 105. The decompression section 107 outputs a composed video signal Pmix3 similar to the decompressed video signal, i.e., the above-mentioned composed video signal Pmix0. The composed video signal Pmix3 is supplied to a video decomposition section 109.

Further, the decompression section 107 transmits the decompression timing to a timing generation section 108. The timing generation section 108 generates a decompression timing signal TM equivalent to each vertical synchronization period (field period) of the video signal output from the decompression section 107. The decompression timing signal TM is then supplied to the video decomposition section 109.

The video decomposition section 109 selects outputs based on the decompression timing signal TM to decompose the composed video signal Pmix3 into respective video signals. That is to say, the video decomposition section 109 selects an output terminal for each field timing to output only odd-numbered fields to the interpolation section 111 and only even-numbered fields to the interpolation section 112 from the composed video signal Pmix3.

The interpolation section 111 is supplied with odd-numbered fields. The supplied video signal has no data for even-numbered fields. Therefore, the interpolation section 111 generates data for even-numbered fields by means of interpolation and outputs an interpolated video signal P1′. The video signal P1′ is a reproduction video signal equivalent to the imaged video signal P1.

The interpolation section 112 is supplied with even-numbered fields. The supplied video signal has no data for odd-numbered fields. Therefore, the interpolation section 112 generates data for odd-numbered fields by means of interpolation and outputs an interpolated video signal P2′. The video signal P2′ is a reproduction video signal equivalent to the imaged video signal P2.

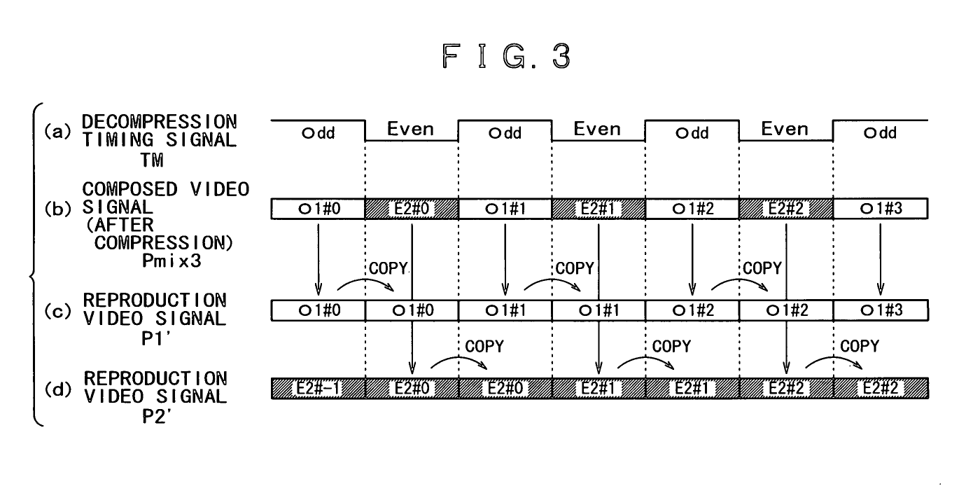

FIG. 3 shows the process so far.

FIG. 3(b) diagrams the composed video signal Pmix3 that is reproduced from the recording medium 90 and is decompressed in the decompression section 107. Like the composed video signal Pmix0 in FIG. 2(d), the composed video signal Pmix3 is a composed video signal comprising an alternate sequence of odd-numbered fields of the imaged video signal P1 and even-numbered fields of the imaged video signal P2. As shown in FIG. 3(b), the composed video signal Pmix3 comprises contiguous fields such as O1#0, E2#0, O1#1, E2#1, O1#2, E2#2, and so on.

As shown in FIG. 3(a), the timing generation section 108 outputs the decompression timing signal TM that indicates a field period in synchronization with the decompression output from the decompression section 107.

The video decomposition section 109 outputs the composed video signal Pmix3 to the interpolation section 111 during a period in which the decompression timing signal TM shows an odd-numbered field. On the other hand, the video decomposition section 109 outputs the composed video signal Pmix3 to the interpolation section 112 during a period in which the decompression timing signal TM shows an even-numbered field.

Accordingly, the interpolation section 111 is supplied with data O1#0, O1#1, O1#2, and so on corresponding to even-numbered fields of the composed video signal Pmix3. The interpolation section 111 performs interpolation, for example, by copying data of the even-numbered field to generate an odd-numbered field, thus generating the video signal P1′ as shown in FIG. 3(c).

The interpolation section 112 is supplied with data E1#0, E1#1, E1#2, and soon corresponding to odd-numbered fields of the composed video signal Pmix3. The interpolation section 112 performs interpolation, for example, by copying data of the odd-numbered field to generate an even-numbered field, thus generating the video signal P2′ as shown in FIG. 3(d).

There may be an alternative to the interpolation by the interpolation sections 111 and 112 that copy field data. Obviously, the other interpolation processes may use correlation between fields, estimation of movement, and the like, for example.

After reproduced from the recording medium 90, the compressed and composed video signal Pmix2 is converted into the video signal P1′ equivalent to the imaged video signal P1 and the video signal P2′ equivalent to the imaged video signal P2. These video signals can be displayed on corresponding display sections 121 and 122.

The imaged video signals P1 and P2 can be transmitted for output in addition to being composed, compressed, and recorded on the recording medium 90.

In this case, there is provided a transmission section 115. This section is supplied with the compressed and composed video signal Pmix1 obtained by the compression section 105.

The transmission section 115 encodes the compressed and composed video signal Pmix1 according to a specified transmission format. The transmission section 115 then transmits the signal to the other devices via a wired or wireless transmission channel.

A reception section 116 is provided for a device to which the compressed and composed video signal Pmix1 is transmitted from the transmission section 115.

The reception device supplies the received compressed and composed video signal Pmix2 (=Pmix1) to the decompression section 107. The reception device also comprises the decompression section 107, the timing generation section 108, the video decomposition section 109, and the interpolation sections 111 and 112 so as to be able to obtain video signals P1′ and P2′ as mentioned above. These signals can be displayed on the specified display sections 121 and 122.

There may be a variety of transmission channels between the transmission section 115 and the reception section 116. Available transmission channels include, for example, networks such as public line, leased line, satellite communication, LAN, Internet, and the like; wireless communication, infrared data communication, optical communication, optical fiber network, near field communication, and broadcast communication.

The embodiment of the present invention has the above-mentioned basic configuration.

According to this configuration, one compression section 105 can function as a processing system for two-system imaged video signals P1 and P2. The recording and reproduction section just needs to record and reproduce one system of compressed and composed video signals. That is to say, the recording and reproduction section just needs to perform ordinary recording and reproduction processes. Likewise, the transmission section 115 and the reception section 116 can realize communication for two-system video signals by means of the ordinary communication for one-system video signals.

The recording medium 90 just needs to record data for two systems using the amount of data for one system. Accordingly, it is possible to save the capacity of the recording medium 90 and appropriately provide long-time imaging. This also results in decreasing the amount of data for communication, improving the communication rate or providing possibility of communication using a low-rate transmission channel.

One decompression section 107 can be used to decompress the reproduced or received compressed and composed video signal Pmix2.

Further, the video composition section 104 and the video decomposition section 109 simply perform selection at field timings. Very simple circuit configurations can be used for realizing these sections.

Consequently, a simplified configuration can be used for the device that simultaneously processes two systems of the imaged video signals P1 and P2. This is preferable to cost saving and miniaturization.

In the configuration of FIG. 1, there may be a case where one of the first and second camera sections 101 and 102 need not process imaged video signals, i.e., only either camera section needs to be used for imaging. In such case, a simple solution is to select imaged video signals for either camera section without performing the field-based selection by the video composition section 104.

That is to say, the present invention can be very easily applied to processes of ordinary one-system imaged video signals.

According to the configuration in FIG. 1, the embodiment of the video signal processing apparatus according to the present invention just needs to comprise at least the video composition section 104 and the compression section 105. Moreover, it may be preferable to add the recording and reproduction section 106 or the transmission section 115.

The embodiment of the video signal processing apparatus according to the present invention just needs to comprise at least the decompression section 107, the timing generation section 108, and the video decomposition section 109. Further, it may be preferable to add the recording and reproduction section 106 or the reception section 116. Furthermore, it may be preferable to add the interpolation sections 111 and 112.

The embodiment of the imaging apparatus according to the present invention just needs to comprise the first and second camera sections 101 and 102, the synchronization signal generation section 103, the video composition section 104, and the compression section 105. Further, it may be preferable to add the recording and reproduction section 106 or the transmission section 115.

The embodiment of the reproduction apparatus according to the present invention just needs to comprise the recording and reproduction section 106, the decompression section 107, the timing generation section 108, and the video decomposition section 109. Further, it may be preferable to add the interpolation sections 111 and 112.

The embodiment of the reception apparatus according to the present invention just needs to comprise the reception section 116, the decompression section 107, the timing generation section 108, and the video decomposition section 109. Further, it may be preferable to add the interpolation sections 111 and 112.

The video signal processing method according to the present invention just needs to perform the processes as described in FIGS. 1 and 2.

Further, the video signal processing method according to the present invention just needs to perform the processes as described in FIGS. 1 and 3.

The following describes examples of the embodiment more specifically.

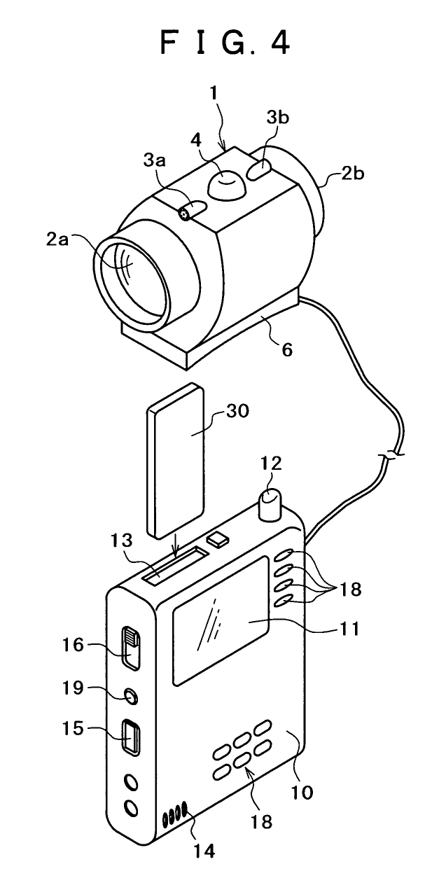

FIG. 4 shows an external view of the video camera appropriately used for not only ordinary users, but also police persons and guards for the security purpose.

The video camera comprises a camera unit 1 and a control unit 10. The camera unit 1 is connected to the control unit 10 via a cable 31 so as to be able to transmit signals.

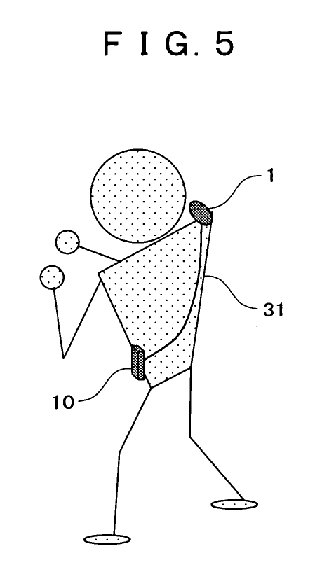

The camera unit 1 is attached to a user's shoulder as shown in FIG. 5, for example. The control unit 10 is configured to be attached to a user's waist or held in a clothing pocket. That is to say, the camera unit 1 and the control unit 10 are configured to be capable of imaging in a portable manner without necessitating the user to use his or her hands.

Though not detailed here, there may be various techniques for attaching the camera unit 1 to the shoulder. For example, a user's clothing such as a security jacket may be provided with a mechanism to support a base 6 of the camera unit 1. Alternatively, the camera unit 1 may be attached to the shoulder by means of an attachment belt.

The camera unit 1 can be attached to the top or the side of a helmet worn by the user, or attached to the user's chest or arm. However, the shoulder causes the least shake when the user is walking, and therefore is assumed to be the best part of the body for attaching the camera unit 1 for imaging.

As shown in FIG. 4, the camera unit 1 is provided with two camera sections: a front camera section 2a and a rear camera section 2b. A front microphone 3a and a rear microphone 3bare provided correspondingly to the front and rear camera sections 2a and 2b.

When the camera unit 1 is attached as shown in FIG. 5, the front camera section 2a is used to image a scene in front of the user. The rear camera section 2b is used to image a scene in the rear of the user.

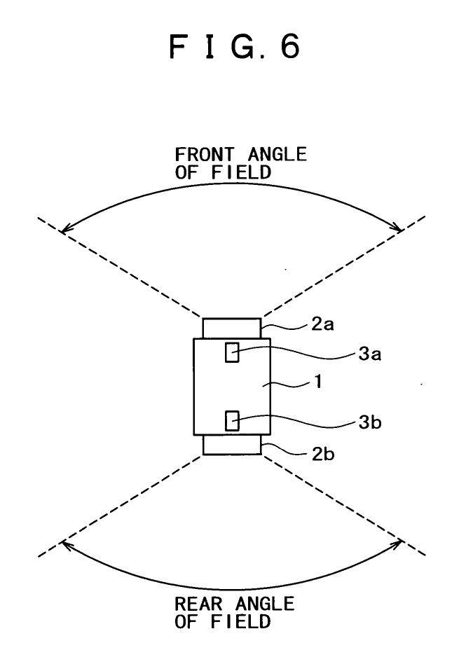

The front and rear camera sections 2a and 2b each use a wide angle lens that provides a relatively wide angle of field for imaging as shown in FIG. 6. A combination of the front and rear camera sections 2a and 2b makes it possible to image almost all around the user.

The front microphone 3a is configured to exhibit strong directivity toward the front of the user postured as shown in FIG. 5 and collects sound corresponding to the scene imaged by the front camera section 2a.

The front microphone 3b is configured to exhibit strong directivity toward the rear of the user postured as shown in FIG. 5 and collects sound corresponding to the scene imaged by the rear camera section 2b.

Obviously, the lens system to be used and the like can determine a variety of front and rear angles of field as imaging ranges for the front and rear camera sections 2a and 2b. The angle of field may be determined in accordance with a situation in which the video camera is expected to be used. Of course, the front angle of field does not necessarily equal the rear angle of field. Further, it is possible to intentionally narrow the angle of field depending on camera models.

The same applies to the directivity of the front and rear microphones 3a and 3b. Various designs are possible depending on uses. For example, the configuration can be designed to use one omnidirectional microphone.

A light emitting section 4 is formed at the top of the camera unit 1. For example, an LED element is used for light emission. The light emitting section 4 emits light when the front and rear camera sections 2a and 2b perform imaging. The light may be emitted continuously intermittently.

Light emission from the light emitting section 4 explicitly notifies those around the user that the video camera is operating for imaging. This alerts those around the user that the video camera is not used for covert purposes. When a policeperson or a guard uses the video camera, for example, the light emitting section 4 indicates that the imaging is in process, thus improving security effects.

The control unit 10 has functions to record video and audio signals obtained by the camera unit 1 on the memory card and transmit signals to a management station (to be described) from an antenna 12. The control unit 10 also provides a user interface function for displays and manipulations.

For example, the front of the control unit 10 is provided with a display section 11 using an liquid crystal panel or the like.

The antenna 12 for communication is provided at a specified position.

A card slot 13 is provided to mount the memory card 30.

There are provided portions for a speaker 14 and a headphone terminal 19 to generate electronic sounds and the voice.

A cable connection terminal 15 is provided for data transmission to information devices according to a specified transmission standard such as USB and IEEE1394.

In addition, there are provided input/output terminals for video and audio signals such as digital in/out terminals, line in/out terminals, and the like.

Operation devices manipulated by a user include a power supply switch 16 and various operation keys 18.

The operation keys 18 may be available as a cursor key, an enter key, a cancel key, and the like capable of various operations and inputs using a cursor on the display section 11. Alternatively, there may be provided special keys for starting and stopping the imaging, setting modes, sending and receiving signals, and the other operations.

The power supply switch 16 and the operation keys 18 may use not only a slide switch and push-button switches as shown in FIG. 4, but also the other operation devices such as a jog dial, a trackball, and the like in combination with the slide and push-button switches, if necessary.

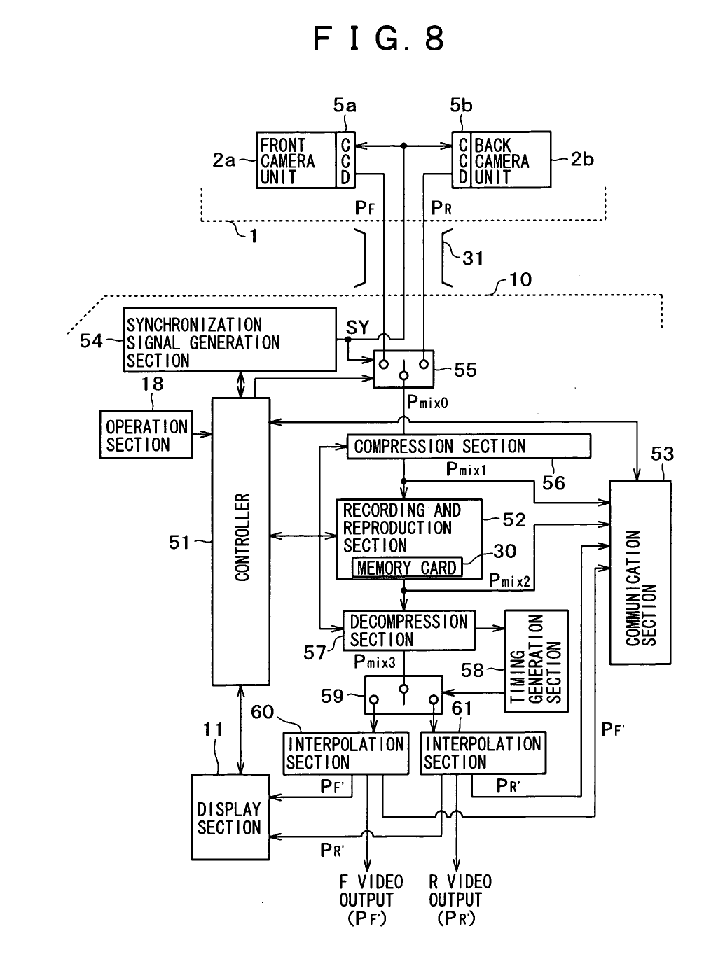

The configuration of the video camera according to this example will be described in more detail with reference to FIG. 8. Hands-free and almost unintentional imaging becomes available when the user carries the video camera comprising the camera unit 1 and the control unit 10 according to the example in the manner as shown in FIG. 5. Therefore, the video camera is appropriate for imaging a working scene while the user is working, or imaging an event while the user enjoys it. Further, the video camera is appropriate for imaging while a guard or a policeperson is on patrol.

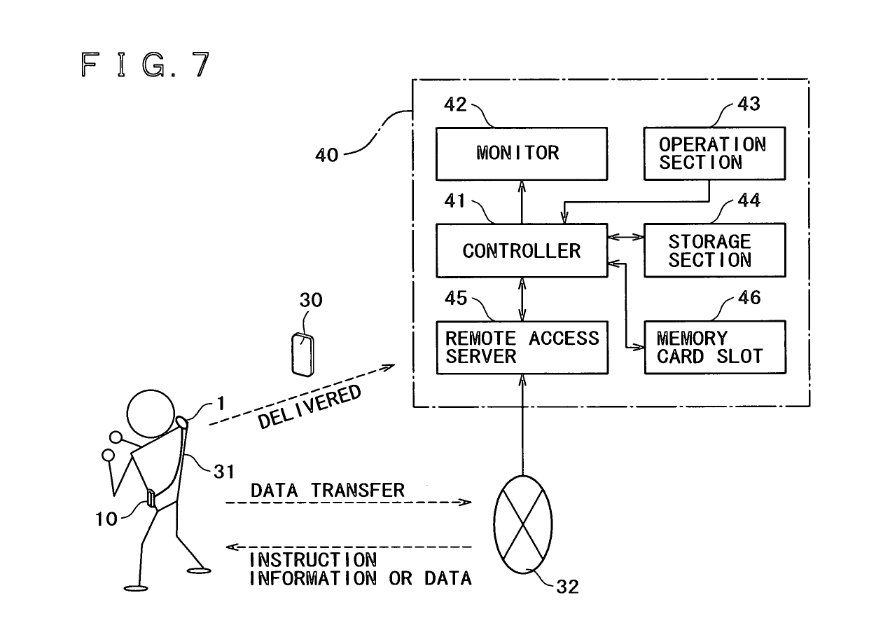

The video camera according to the example has the functions of recording imaged video data on the memory card 30 and transmitting this data. FIG. 7 shows a system example of applying these functions to guard and police uses, for example.

The control unit 10 of the video camera is capable of data communication with a management station 40 via a public line 32, for example. For this purpose, the control unit 10 is provided with a communication function such as a cellular phone or PHS. The communication may be made available via a leased line instead of the public line 32.

The management station 40 represents, for example, an organization or the like that commands or manages one or more policepersons or guards who carry the video camera according to the example.

The management station is equipped with a controller 41, a monitor section 42, an operation section 43, a storage section 44, a remote access server 45, a memory card slot 46, and the like.

The controller controls a system in the management station 40.

The monitor section 42 comprises, for example, a display, a speaker, and the like, and outputs audiovisual data to an operator.

The operation section 43 comprises an operation device such as a keyboard, a microphone, a camera, and the like, and allows an operator to perform various operations and enter information.

The storage section 44 comprises an HDD (hard disk drive), an optical disk drive, a magnetic tape drive, or the like, and records and reproduces information from a recording medium.

The remote access server 45 performs communication operations between the management station 40 and the video camera's control unit 10 via the public line 32.

The memory card slot 46 is used for the memory card 30 used as a recording medium for the control unit 10 of the video camera. The memory card slot 46 can access the memory card 30 under control of the controller 41.

The control unit 10 carried by a guard and the like is provided with a function to transmit video data (or audiovisual data) obtained by the camera unit 1. That video data is transmitted to the management station 40 via the public line 32.

Under control of the controller 41, the management station 40 can store the transmitted video data in the storage section 44 and output the data as video and voice to the monitor section 42.

While a guard or the like is on patrol by carrying the video camera, an operator at the management station 40 can also confirm scenes and sounds in a place where the guard or the like is on patrol. The audiovisual data during the patrol can be stored and used for later investigation or analysis, and as corroborative data.

Further, it is possible to enhance effects of preventing crimes and improving safety for guards and the like by making it public that the management station 40 also monitors audiovisual data obtained by the video camera used by the guard or the like.

The guard or the like can obtain audiovisual data using the video camera and record that data on the memory card 30 mounted in the control unit 10. The memory card 30 can be used as a patrol report if the guard or the like delivers the memory card 30 to the management station 40 after the patrol. The management station 40 receives the memory card 30 from the guard or the like and inserts it into the memory card slot 46. The audiovisual data recorded on the memory card 30 is read under control of the controller 41. The audiovisual data can be then output to the monitor section 42 or stored in the storage section 44.

The management station 40 can send various directive information or data to the video camera (control unit 10).

Further, guard directives can be transmitted as audiovisual and text data. It is possible to transmit a map and a criminal's photo or montage picture in the form of audiovisual data for patrol materials.

The video camera's control unit 10 generates sounds as operator directions or materials from the speaker 14 or the headphone terminal 19 to the user

The user can use the display section 11 to view image or text data transmitted as the directions or materials.

While there has been described the communication between the video camera and the management station 40, a plurality of guards and the like may directly perform data communication, for example.

For example, the communication is available via general public lines by using the communication function of the cellular phone or PHS for the communication function of the control unit 10. In this case, the management station 40 may function as a so-called relay station.

While the system in FIG. 7 has been described as being designed for guard and police uses, the system can be also used for ordinary users.

For example, the function equivalent to the management station 40 is given to a computer at the user's home so as to be able to transmit audiovisual data obtained by the video camera. The user can save the imaged video data in an HDD and the like of the personal computer at his or her home.

In this manner, the user can perform imaging without needing to worry about the memory card 30 whether it is unavailable or it has insufficient capacity during imaging.

FIG. 8 shows a configuration example of the video camera. FIG. 8 particularly shows a processing system related to imaged video signals and omits parts not directly concerned with video signal processing.

As mentioned above, the camera unit 1 is provided with the front camera section 2a and the front camera section 2b.

Imaging light captured by the front camera section 2a is converted into an electrical signal in a CCD section 5a. The signal passes through gain adjustment, an A/D converter, and the other specified signal processes to become an imaged video signal PF. This signal is then supplied to the control unit 10 via the cable 31.

Likewise, imaging light captured by the rear camera section 2b is converted into an electrical signal in a CCD section 5b. The signal passes through gain adjustment, an A/D converter, and the other specified signal processes to become an imaged video signal PR. This signal is then supplied to the control unit 10 via the cable 31.

The control unit 10 (or the camera unit 1) is provided with a synchronization signal generation section 54 to supply a common synchronization signal SY to the front and rear camera sections 2a and 2b.

Consequently, the front and rear camera sections 2a and 2b synchronously perform imaging processes to output the synchronized imaged video signals PF and PR.

In the control unit 10, a controller 51 controls overall operations. The controller 51 comprises a micro computer having a CPU, RAM, ROM, flash ROM, and the like.

In the camera unit 1, the front and rear camera sections 2a and 2b transmit the imaged video signals PF and PR through the cable 31, respectively. The imaged video signals PF and PR are supplied to corresponding terminals of a video composition section 55.

The video composition section 55 is supplied with the synchronization signal SY from the synchronization signal generation section 54. The connection terminals are changed based on the synchronization signal SY. That is to say, as shown in FIGS. 1 and 2, the connection terminals are changed according to the vertical synchronization timing (field timing). In this manner, the video composition section 55 outputs the composed video signal Pmix0 comprising a sequence of odd-numbered fields of the imaged video signal PF and even-numbered fields of the imaged video signal PR, for example.

The composed video signal Pmix0 is supplied to the compression section 56 and is subject to an MPEG compression process, for example. The signal is converted into the compressed and composed video signal Pmix1 and is supplied to a recording and reproduction section 52.

The recording and reproduction section 52 records or reproduces data from the memory card 30 mounted in the memory card slot 13 in FIG. 4. The controller issues a read/write control signal to control access operations of the recording and reproduction section 52.

Under control of the controller 51, the recording and reproduction section 52 records the compressed and composed video signal Pmix1 supplied from the compression section 56 onto the memory card 30.

The imaged video signals PF and PR are composed and compressed to generate the compressed and composed video signal Pmix1. The recording and reproduction section 52 encodes the signals into a recording format on the memory card 30 and records the compressed and composed video signal Pmix1 as one video content.

Under control of the controller 51, the recording and reproduction section 52 reads video data recorded on the memory card 30.

The video signal Pmix2 reproduced from the memory card 30 corresponds to the state of the above-mentioned video signal Pmix1, i.e., a compressed and composed video signal.

The reproduced compressed and composed video signal Pmix2 is supplied to a decompression section 57. The decompression section 57 performs a decompression process corresponding to the compression process in the above-mentioned compression section 56. The decompression section 57 outputs the decompressed video signal, i.e., the composed video signal Pmix3 equivalent to the above-mentioned composed video signal Pmix0. The composed video signal Pmix3 is supplied to a video decomposition section 59.

The decompression section 57 transmits the decompression timing to a timing generation section 58. The timing generation section 58 generates the decompression timing signal TM corresponding to each vertical synchronization period (field period) for the video signal out put from the decompression section 57. The decompression timing signal TM is then supplied to the video decomposition section 59.

The video decomposition section 59 decomposes the composed video signal Pmix3 into respective video signals by changing outputs based on the decompression timing signal TM. That is to say, the video decomposition section 59 outputs only odd-numbered fields to the interpolation section 60 and only even-numbered fields to the interpolation section 61 from the composed video signal Pmix3, for example.

The interpolation section 60 is supplied with odd-numbered fields. The supplied video signal has no data for even-numbered fields. Therefore, the interpolation section 60 generates data for even-numbered fields by interpolation. The interpolation section 60 then outputs an interpolated video signal PF′, i.e., a reproduced video signal equivalent to the imaged video signal PF.

The interpolation section 61 is supplied with even-numbered fields. The supplied video signal has no data for odd-numbered fields. Therefore, the interpolation section 61 generates data for odd-numbered fields by interpolation. The interpolation section 61 then outputs an interpolated video signal PR′, i.e., a reproduced video signal equivalent to the imaged video signal PR.

Processes of the video decomposition section 59 and the interpolation sections 60 and 61 are the same as those described with reference to FIGS. 1 and 3 above.

The display section 11 can display the video signals PF′ and PR′ that are reproduced from the memory card 30 in this manner.

The controller 51 displays a reproduced video on the display section 11 in accordance with user operations from an operation section 18, for example.

In this case, one display section 11 is simultaneously supplied with two systems of the video signals PF′ and PR′. There may be various display modes.

For example, one of the video signals PF′ and PR′ may be selectively displayed in accordance with user operations. That is to say, the user selects the front or rear video for display at his or her discretion. Of course, when the user switches between the front and rear videos during reproduction, the display just needs to be changed to the other video signal.

The display area of the display section 11 maybe split into two screens to display two videos simultaneously. The display area may provide not only two screens split at a one-to-one ratio, but also a so-called picture-in-picture frame comprising a sub-screen inserted into a main screen.

Further, the control unit 10 may be provided with two display sections. In this case, the respective display sections can display the front video (video signal PF′) and the rear video (video signal PR′).

While there has been described the use of the display section 11 for displaying reproduced videos, the display section 11 can be also used as a monitoring display section during imaging.

Though not shown here, a configuration for monitor display may directly supply the display section 11 with the imaged video signal PF from the front camera section 2a and the imaged video signal PR from the rear camera section 2b.

The video signals PF′ and PR′ are reproduced from the memory card 30 and are output from the interpolation sections 60 and 61. The video signals PF′ and PR′ can be also output to external devices from the above-mentioned cable connection terminal 15 and the video signal output terminals. The cable connection terminal 15 is provided for data transmission to information devices according to specified transmission standards such as USB and IEEE1394. The video signal output terminals include digital-out, line-out, and the like.

In this case, an external display apparatus can be used to display the reproduced videos such as the front and rear videos.

As mentioned above, the video camera according to the example has the communication function. As shown in FIG. 7, for example, the video camera can transmit data to the management 40 or a terminal at the user's home.

For this purpose, the control unit 10 is provided with a communication section 53. Under control of the controller 51, the communication section 53 performs processes for the transmission such as encoding, modulation, and high frequency modulation and amplification. The control unit 10 then transmits data from the antenna 12. The transmitted data is received by the management station 40, for example.

The communication section 53 receives data transmitted from the management station and the like, decodes that data, and supplies the received data to the controller 51 and the like.

During imaging, the communication section 53 is supplied with the compressed and composed video signal Pmix1 from the compression section 56, for example. During reproduction of the memory card 30, the communication section 53 is supplied with the compressed and composed video signal Pmix2 reproduced by the recording and reproduction section 52.

The communication section 53 applies a transmission process to the compressed and composed video signal Pmix1 (Pmix2) and transmits it to the management station 40 and the like.

That is to say, the communication section 53 transmits video data comprising two systems of composed and compressed imaged video signals.

In this case, the management station 40 and the like as the receiving side just need to have the receiving-side configuration as described for the remote access server 45 in FIG. 1.

For example, the remove access server 45 is configured to comprise the reception section 116, the decompression section 107, the timing generation section 108, the video decomposition section 109, and the interpolation sections 111 and 112.

The remote access server 45 can obtain two systems of the video signals PF′ and PR′ by performing the process as shown in FIG. 3 for the received compressed and composed video signal Pmix1 (Pmix2).

The monitor 42 displays the video signals PF′ and PR′. In this manner, an operator at the management station 40 and the like can view the front and rear videos imaged by the video camera of course, it is possible to record the front and rear videos as independent video contents on a recording medium in a storage 44.

In the management station 40 and the like as the receiving side, the storage section 44 may have the configuration for the reproduction side.

That is to say, the reproduction system of the storage section 44 is configured to comprise the decompression section 107, the timing generation section 108, the video decomposition section 109, and the interpolation section 111 and 112 in FIG. 1.

In this case, the remote access server 45 receives the compressed and composed video signal Pmix1 (Pmix2). The storage section 44 unchangedly records this signal as one video content on the recording medium. During reproduction of the video contents, it is possible to obtain two systems of video signals PF′ and PR′ by performing the processes as shown in FIG. 3 in the decompression section 107, the timing generation section 108, the video decomposition section 109, and the interpolation section 111 and 112.

The monitor 42 displays the video signals PF′ and PR′. In this manner, an operator at the management station 40 and the like can view the front and rear videos imaged by the video camera. While the front and rear videos are separated into two systems during reproduction, the storage 44 can also rerecord these videos as independent video contents on the recording medium.

The description about FIG. 7 includes the case of delivering the memory card 30 to the management station after the video camera records video data on the memory card 30. As will be understood from the description of FIG. 8, the memory card 30 records the compressed and composed video signal Pmix1.

In this case, the memory card slot 46 for the management station 40 needs to comprise the reproduction system in FIG. 1. That is to say, there are provided the decompression section 107, the timing generation section 108, the video decomposition section 109, and the interpolation section 111 and 112. Performing the processes as shown in FIG. 3 can obtain two systems of video signals PF′ and PR′ when the memory card 30 is reproduced. The monitor 42 displays the video signals PF′ and PR′. In this manner, an operator at the management station 40 and the like can view the front and rear videos imaged by the video camera. The storage 44 can also rerecord the front and rear videos as independent video contents on a recording medium.

In the video camera according to the configuration as shown in FIG. 8, for example, it is also possible to supply the communication section 53 with the video signal PF′ or PR′ output from the interpolation section 60 or 61 for transmission to the management station 40 and the like. Since two systems of video signals are transmitted in this case, the receiving side may use an ordinary device.

Further, the communication section 53 may be supplied with the composed video signal Pmix0 output from the video composition section 55 before the compression and the composed video signal Pmix3 output from the decompression section 57 after the decompression for transmission.

Moreover, the communication section 53 may receive the compressed and composed video signal Pmix1 (Pmix2) from another video camera or another management station 40 having the similar configuration. In such case, it is possible to supply the received compressed and composed video signal Pmix1 (Pmix2) to the recording and reproduction section 52 and record that signal as one video content on the memory card 30. Furthermore, it is also possible to supply the received compressed and composed video signal Pmix1 (Pmix2) to the decompression section 57 for decompression and generate two systems of video signals PF′ and PR′ by means of the processes of the video decomposition section 59 and the interpolation sections 60 and 61.

As mentioned above, the present invention provides the effects of the descriptions about FIGS. 1 and 2 according to the examples with reference to FIGS. 4 through 8. That is to say, it is possible to simplify the apparatus configuration, save costs, permit long-time imaging by economizing the recording capacity on the memory card 30, decrease the amount of communication data, and the like.

As mentioned above, the management station 40 and the like according to the example has the reproduction or reception configuration as shown in FIG. 1. This makes it possible to more efficiently use videos imaged, compressed, and composed by the video camera in FIG. 4.

While there has been described the specific embodiment of the present invention, the present invention may be otherwise variously embodied.

For example, it is to be distinctly understood that FIGS. 4 through 8 exemplify external views of the camera unit 1 and the control unit 10. The present invention places no limitations on operation devices, display disposition, the frame shape, and the like for the actual user interface. Of course, various shapes may be designed depending on different configurations.

According to the embodiment, the camera unit 1 is connected to the control unit 10 via the cable 31. Further, it may be preferable to wirelessly transmit imaged video signals or audio signals by means of a transmitter using a radio wave or an infrared ray.

Alternatively, the camera unit 1 and the control unit 10 may be integrated into a single unit rather than the separate units as shown in FIG. 4.

There are provided two camera sections as the first and second camera sections 101 and 102 in FIG. 1 or the front and rear camera sections 2a and 2b in FIG. 4. It may be preferable to provide three or more camera sections.

If three or more camera sections are provided, the process of the video composition section 55 is unchanged. That is to say, the video composition section 55 selects each imaged video signal in units of fields.

The video composition section 55 may select each imaged video signal in units of frames (two fields) instead of fields.

The video composition process is likewise available for noninterlaced imaged video signals by selecting them at the vertical synchronization timing.

It may be preferable to provide a pan-tilt mechanism for all or part of a plurality of camera sections to be able to change imaging directions vertically and horizontally.

Pan-tilt operations may be controlled manually by a user or automatically by the controller 51.

The memory card 30 is used as a recording medium for the example in FIGS. 4 through 8. Further, the control unit 10 may be provided with a disk drive apparatus for optical disks or magnetic optical disks to record imaged videos on these disk recording media. Of course, magnetic tape may be used as recording media.

All the blocks as constituent elements in FIG. 8 are not required. The other constituent elements may be added.

For example, imaged video data may be only transmitted without providing the recording function. On the contrary, imaged video data may be only recorded without providing the communication function.

When there is provided a plurality of camera sections as shown in FIGS. 4 through 8, only one camera section (e.g., only the front camera section 2a) may be used for imaging. In such case, the controller 51 just needs to provide control so that the video composition section 55 does not make selections in units of fields. To use only the front camera section 2a, for example, the video composition section 55 just needs to continuously select only a sequence of imaged video signals PF.

Therefore, it is possible to choose from the simultaneous imaging using a plurality of camera sections and the imaging using a single camera section.

In the example of FIGS. 1 or 8, the interpolation sections 111 and 112 (or the interpolation sections 60 and 61) interpolate field data to obtain video signals at the same rate as for the imaging. However, no interpolation may be needed depending on output destinations of the reproduced video, display modes, and the other conditions.

In the example of FIG. 8, no interpolation halves the number of fields for the video signals PF′ and PR′ compared to that for the imaged video signals PF and PR. Interlaced data comprises half the number of scan lines in units of frames. Displaying such data as is produces a horizontally long picture. In other words, no interpolation is needed if displaying a horizontally long picture causes no problem.

Already halving the number of scan lines is appropriate for a case where the reproduced video needs to be reduced or split into screens. In such case, the interpolation may be replaced by horizontal data skipping, for example.

In addition, the interpolation can be omitted from the CCTV (ClosedCircuit TV) system that can use only field signals in the video signal, for example.

As seen from the examples of FIGS. 1 and 8, the present invention compresses the composed video signal Pmix0 and generates the compressed and composed video signal Pmix1 to be recorded on a recording medium or to be transmitted.

Further, there may be a system that records the composed video signal Pmix0 on a recording medium or transmits the signal without compression and decompression depending on recording capacities of recording media, communication rates, video data amounts, and the other conditions.

Moreover, according to the above-mentioned embodiment, the video composition section 104 (55) is synchronously supplied with the video signals P1 and P2 (PF and PR) that are imaged video signals generated by the camera section.

However, the video signal processing apparatus and the video signal processing method according to the present invention do not necessarily require imaging means such as the camera section to supply the plurality of synchronized video signals. For example, a plurality of video reproduction apparatuses can perform synchronization operations. Based on these operations, a plurality of systems of synchronized video signals can be simultaneously reproduced from a plurality of recording media. The video composition section 104 and the compression section 105 can process these reproduced video signals.

In this case, it is possible to compose a plurality of video contents already recorded on a recording medium, and then rerecord a composed video content on the recording medium or transmit it.

Furthermore, when receiving a plurality of systems of synchronized video signals, the video composition section 104 and the compression section 105 can process each of the received video signals.

That is to say, a plurality of video signals just need to be synchronized. The present invention can be variously embodied according to video signals.

As will be understood from the above-mentioned description, the present invention selects a plurality of synchronized video signals at the vertical synchronization timing to generate one system of composed video signal. Here, the synchronized video signals are obtained by a plurality of imaging means and the like, for example. Accordingly, compression means just needs to compress one system of composed video signal. Likewise, after a plurality of systems of video signals (imaged video signals) is composed, recording means and transmission means just need to record and transmit a compressed and composed video signal.

Still further, one-system decompression means can be used to decompress a compressed and composed video signal that is reproduced from the recording medium or is received. The video decomposition process can recover the original plurality of systems of video signals simply by selecting the signals at the vertical synchronization timing. It is a good practice to interpolate a field that is lost due to the field-based selection during the composition.

These considerations greatly simplify the configurations of the portions that compress, record, transmit and receive, reproduce, and decompress a plurality of systems of synchronized video signals (imaged video signals). Consequently, it is possible to realize the miniaturization, simplification, and cost saving with respect to the circuit scale of the signal processing apparatus, the imaging apparatus, the reproduction apparatus, the reception apparatus, and the like that simultaneously process a plurality of systems of synchronized video signals (imaged video signals). In addition, it is possible to decrease the amount of data to be recorded or transmitted, enabling long-time recording and improving the communication speed.

What is claimed is:

1. A video signal processing apparatus comprising:
composition means for sequentially selecting a plurality of video signals supplied synchronously with the same synchronization signal at a vertical synchronization timing of said synchronization signal to obtain a composed video signal comprising a composition of said video signals; and
compression means for compressing a composed video signal obtained by said composition means.

2. The video signal processing apparatus according to claim 1 further comprising:
recording means for recording on a recording medium a compressed and composed video signal compressed by said compression means.

3. The video signal processing apparatus according to claim 1 further comprising:
transmission means for transmitting a compressed and composed video signal compressed by said compression means.

4. A video signal processing apparatus comprising:
composition means for sequentially selecting and composing a plurality of video signals supplied synchronously with the same synchronization signal at a vertical synchronization timing of said synchronization signal;
decompression means for applying a decompression process to a compressed and composed video signal compressed after composition by said composition means to obtain a decompressed composed video signal; and
video decomposition means for sequentially selecting a composed video signal output from said decompression means at a vertical synchronization timing to obtain a plurality of video signals.

5. The video signal processing apparatus according to claim 4 further comprising:
interpolation means for interpolating a video signal output from said video decomposition means.

6. The video signal processing apparatus according to claim 4 further comprising:
reproduction means for a recording medium,
wherein a compressed and composed video signal input to said decompression means is reproduced by said reproduction means from a recording medium.

7. The video signal processing apparatus according to claim 4 further comprising:
reception means,
wherein a compressed and composed video signal input to said decompression means is received by said reception means.

8. A video signal processing method comprising the steps of:
sequentially selecting a plurality of video signals supplied synchronously with the same synchronization signal at a vertical synchronization timing of said synchronization signal to obtain a composed video signal comprising a composition of said plurality of video signals;
compressing said composed video signal; and
recording on a recording medium or transmitting said compressed and composed video signal.

9. A video signal processing method comprising the steps of:
sequentially selecting and composing a plurality of video signals supplied synchronously with the same synchronization signal at a vertical synchronization timing of said synchronization signal;
applying a decompression process to a compressed and composed video signal compressed after composition in correspondence with said compression process to obtain a decompressed composed video signal; and
sequentially selecting said composed video signal at a vertical synchronization timing to output a plurality of video signals.

10. The video signal processing method according to claim 9 further comprising the step of:
interpolating said output video signal.

11. An imaging apparatus comprising:
synchronization signal generation means;
a plurality of imaging means for performing imaging based on a synchronization signal from said synchronization signal generation means to output an imaged video signal;
composition means for sequentially selecting a plurality of imaged video signals obtained by said plurality of imaging means at a vertical synchronization timing of said synchronization signal to obtain a composed video signal comprising a composition of said plurality of imaged video signals; and
compression means for compressing a composed video signal obtained by said composition means.

12. The imaging apparatus according to claim 11 further comprising:
recording means for recording on a recording medium a compressed and composed video signal compressed by said compression means.

13. The imaging apparatus according to claim 11 further comprising:
transmission means for transmitting a compressed and composed video signal compressed by said compression means.

14. A reproduction apparatus comprising:
reproduction means for reproducing from a recording medium a compressed and composed video signal generated by sequentially selecting and composing a plurality of imaged video signals obtained by a plurality of imaging means for performing imaging based on the same synchronization signal and by compressing said imaged video signals after composition, wherein said sequential selection is performed at a vertical synchronization timing of said synchronization signal;
decompression means for decompressing a compressed and composed video signal reproduced by said reproduction means from a recording medium in correspondence with said compression process to obtain a decompressed composed video signal; and
video decomposition means for sequentially selecting a composed video signal from said decompression means at a vertical synchronization timing to obtain a plurality of video signals.

15. The reproduction apparatus according to claim 14 further comprising:
interpolation means for interpolating a video signal output from said video decomposition means.

16. A reception apparatus comprising:
reception means for receiving a compressed and composed video signal generated by sequentially selecting and composing a plurality of imaged video signals obtained by a plurality of imaging means for performing imaging based on the same synchronization signal and by compressing said imaged video signals after composition, wherein said sequential selection is performed at a vertical synchronization timing of said synchronization signal;
decompression means for decompressing a compressed and composed video signal received by said reception means in correspondence with said compression process to obtain a decompressed composed video signal; and
video decomposition means for sequentially selecting a composed video signal from said decompression means at a vertical synchronization timing to obtain a plurality of video signals.

17. The reception apparatus according to claim 16 further comprising:
interpolation means for interpolating a video signal output from said video decomposition means.
